(19) United States
(12) Patent Application Publication
(10) Pub. No.: US 2007/0253379 A1
(43) Pub. Date: Nov. 1, 2007

(54) Method and apparatus for uplink allocation placement in an uplink frame

(75) Inventors: Prachi P. Kumar, Palatine, IL (US); Jiangnan Jason Chen, Hawthorn Woods, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC.

(21) Appl. No.: 11/413,395

(22) Filed: Apr. 28, 2006

(51) Int. Cl. H04Q 7/24

(52) U.S. Cl. 370/338

(57) ABSTRACT

Various embodiments are described to address the need for a method and apparatus that could reduce the start-up delay for uplink data transfers in multiple-access technologies. A time-symbol threshold (551) is introduced for an uplink frame (550) in order to create a partition of the frame that includes the earlier of the available time symbols and in which any bandwidth request allocations may be placed. By placing bandwidth request allocations earlier in the uplink frame (i.e., at or before the time-symbol threshold), remote units are able to send their bandwidth requests to a scheduler sooner and thereby receive a bandwidth grant for an uplink data transfer with less delay.

### REFERENCE(S) TO RELATED APPLICATION(S)

This application is related to a co-pending application, Ser. No. 11/015607, entitled “Method And Apparatus For Determining When To Begin Communication Resource Acquisition,” filed Dec. 17, 2004, which is assigned to the assignee of the present application.

This application is related to a co-pending application, Ser. No. 11/016181, entitled “Method And Apparatus For Predictively Providing An Uplink Communication Source,” filed Dec. 17, 2004, which is assigned to the assignee of the present application.

### FIELD OF THE INVENTION

The present invention relates generally to communications and, in particular, to the placement of uplink allocations in uplink frames.

### BACKGROUND OF THE INVENTION

Many multiple-access technologies feature an arbitrator that schedules which users have access to shared resources at a given time. For example, in technologies such as IEEE (Institute of Electrical and Electronics Engineers) 802.16d and 802.16e (see e.g., http://www.ieee802.org/), Subscriber Stations (SSs)/remote units (RUs) share an uplink to a Base Station (BS) on a demand basis. The start of uplink data transfer (from a Subscriber Station to a Base Station) requires multiple frames of wait-time because of a two-staged bandwidth request/grant procedure.

FIG. 1 is a timing diagram 100 of an example of this two-staged bandwidth request/grant procedure in accordance with prior art techniques. A Subscriber Station/remote unit is allocated a small bandwidth so that it can send in its request for additional bandwidth. Trigger for this allocation is either Subscriber-initiated (by use of contention-based bandwidth request techniques) or Base Station-initiated (for connections that the Base Station decides to poll). When the Subscriber Station receives (110) such an allocation from the Base Station to request additional bandwidth, the Subscriber Station indicates (120) the quantity of bytes associated with uplink data that needs to be transmitted to the Base Station. After two frames, the Subscriber Station receives (130) a bandwidth grant from the Base Station and can then send (140) its uplink data in the following frame.

The delay, as illustrated in diagram 100, with the start of uplink data transfer is particularly pre-dominant in 802.16d/e because they are high capacity, high bandwidth technologies. As illustrated, the actual delay experienced by the Subscriber Station can be approximately 6 frames. Such a delay may be apparent to a system user and may visibly impact Base Station performance. Accordingly, it would be desirable to have a method and apparatus that could reduce the start-up delay for uplink data transfers in these systems.

### BRIEF DESCRIPTION OF THE DRAWINGS

FIG. 1 is a timing diagram of an example of a two-staged bandwidth request/grant procedure in accordance with prior art techniques.

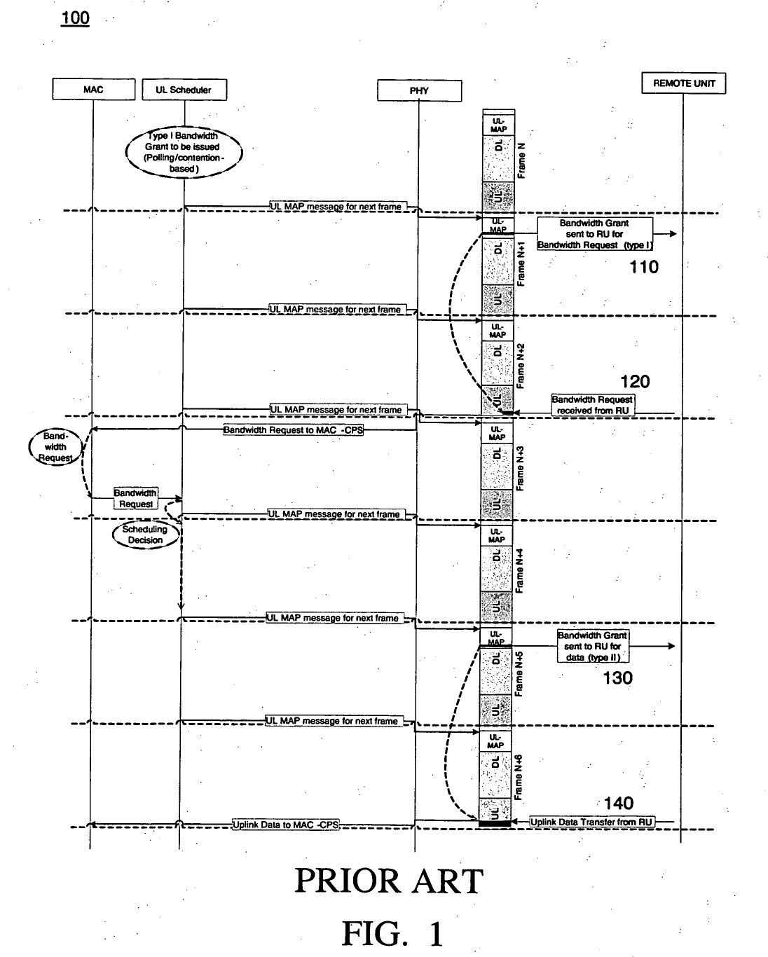

FIG. 2 is a timing diagram of an example of a two-staged bandwidth request/grant procedure in accordance with multiple embodiments of the present invention.

FIG. 3 is a block diagram depiction of a wireless communication system in accordance with multiple embodiments of the present invention.

FIG. 4 is a logic flow diagram of functionality performed in accordance with multiple embodiments of the present invention.

FIG. 5 is a block diagram depiction of two illustrative examples of uplink frames, one illustrating the placement of allocations in accordance with prior art techniques and the other illustrating the placement of allocations in accordance with multiple embodiments of the present invention.

FIG. 6 is a more detailed logic flow diagram of functionality performed in accordance with certain embodiments of the present invention.

FIG. 7 is a block diagram depiction of two illustrative examples of uplink frames in accordance with certain embodiments of the present invention.

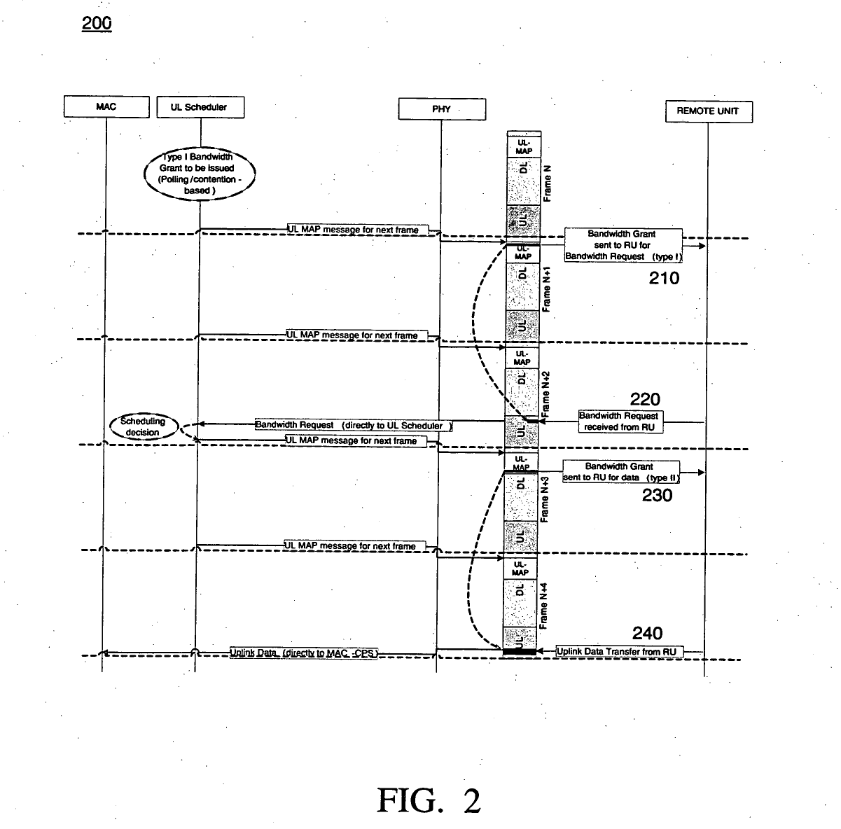

Specific embodiments of the present invention are disclosed below with reference to FIGS. 2-7. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. In addition, although the logic flow diagrams above are described and shown with reference to specific steps performed in a specific order, some of these steps may be omitted or some of these steps may be combined, sub-divided, or reordered without departing from the scope of the claims. Thus, unless specifically indicated, the order and grouping of steps is not a limitation of other embodiments that may lie within the scope of the claims

Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### DETAILED DESCRIPTION OF EMBODIMENTS

Various embodiments are described to address the need for a method and apparatus that could reduce the start-up delay for uplink data transfers in multiple-access technologies. A time-symbol threshold is introduced for an uplink frame in order to create a partition of the frame that includes the earlier of the available time symbols and in which any bandwidth request allocations may be placed. By placing bandwidth request allocations earlier in the uplink frame (i.e., at or before the time-symbol threshold), remote units are able to send their bandwidth requests to a scheduler sooner and thereby receive a bandwidth grant for an uplink data transfer with less delay.

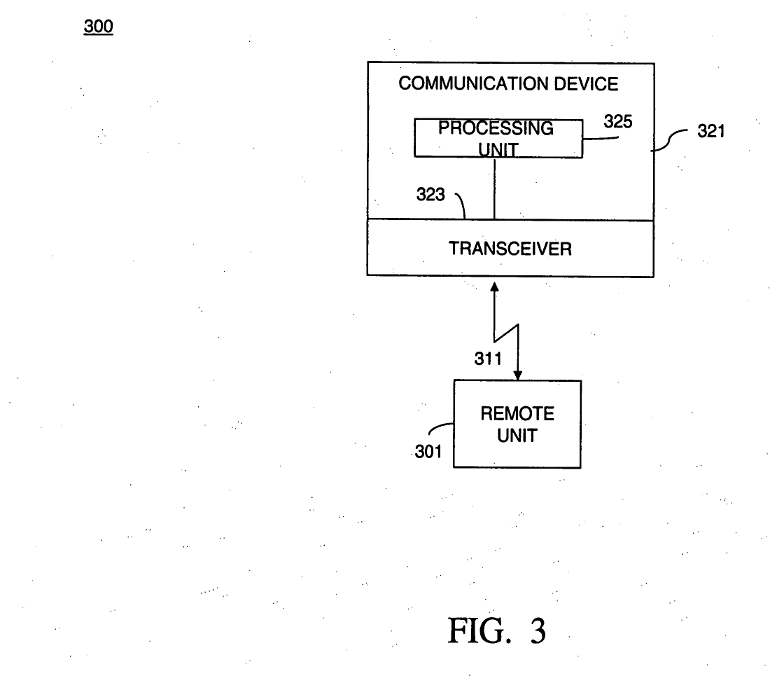

The present invention can be more fully understood with reference to FIGS. 2-7. FIG. 3 is a block diagram depiction of a wireless communication system 300 in accordance with multiple embodiments of the present invention. At present, standards bodies such as OMA (Open Mobile Alliance), 3GPP (3rd Generation Partnership Project), 3GPP2 (3rd Generation Partnership Project 2) and IEEE 802 are developing standards specifications for wireless telecommunications systems. (These groups may be contacted via http://www.openmobilealliance.com, http://www.3gpp.org/, http://www.3gpp2.com/ and http://www.ieee802.org/, respectively.) Communication system 300 represents a system having an architecture in accordance with one or both of the IEEE 802.16d and/or 802.16e technologies, suitably modified to implement the present invention. Alternative embodiments of the present invention may be implemented in communication systems that employ other or additional technologies such as, but not limited to, those described in the 3GPP specifications and/or those described in the 3GPP2 specifications.

Communication system 300 is depicted in a very generalized manner, shown to comprise communication device 321 and remote unit 301. Those skilled in the art will recognize that FIG. 3 does not depict all of the network equipment necessary for system 100 to operate commercially but only those system components and logical entities particularly relevant to the description of embodiments herein. For example, depending on the embodiment, communication device 321 may represent a base transceiver station (BTS), an access point (AP), and/or a higher order device such as a base station (BS) or WLAN (wireless local area network) station or even a radio access network (RAN) or access network (AN); however, none of these devices are specifically shown in FIG. 3.

Remote unit 301 and communication device 321 are shown communicating via technology-dependent, wireless interface 311. Remote units, subscriber stations (SSs) or user equipment (UEs), may be thought of as mobile stations (MSs); however, remote units are not necessarily mobile nor able to move. In addition, remote unit/SS platforms are known to refer to a wide variety of consumer electronic platforms such as, but not limited to, mobile stations (MSs), access terminals (ATs), terminal equipment, mobile devices, gaming devices, personal computers, and personal digital assistants (PDAs). In particular, remote unit 301 comprises a processing unit (not shown) and transceiver (not shown). Depending on the embodiment, remote unit 301 may additionally comprise a keypad (not shown), a speaker (not shown), a microphone (not shown), and a display (not shown). Processing units, transceivers, keypads, speakers, microphones, and displays as used in remote units are all well-known in the art.

In general, components such as processing units and transceivers are well-known. For example, processing units are known to comprise basic components such as, but neither limited to nor necessarily requiring, microprocessors, microcontrollers, memory devices, application-specific integrated circuits (ASICs), and/or logic circuitry. Such components are typically adapted to implement algorithms and/or protocols that have been expressed using high-level design languages or descriptions, expressed using computer instructions, expressed using signaling flow diagrams, and/or expressed using logic flow diagrams.

Thus, given a high-level description, an algorithm, a logic flow, a messaging/signaling flow, and/or a protocol specification, those skilled in the art are aware of the many design and development techniques available to implement a processing unit (such as processing unit 325) that performs the given logic. Therefore, communication device 321 represents a known device that has been adapted, in accordance with the description herein, to implement multiple embodiments of the present invention.

Furthermore, those skilled in the art will recognize that aspects of the present invention may be implemented in and/or across various physical components and none are necessarily limited to single platform implementations. For example, the communication device may be implemented in or across one or more networked or otherwise communicatively coupled devices, such as communication infrastructure devices and/or wireless devices.

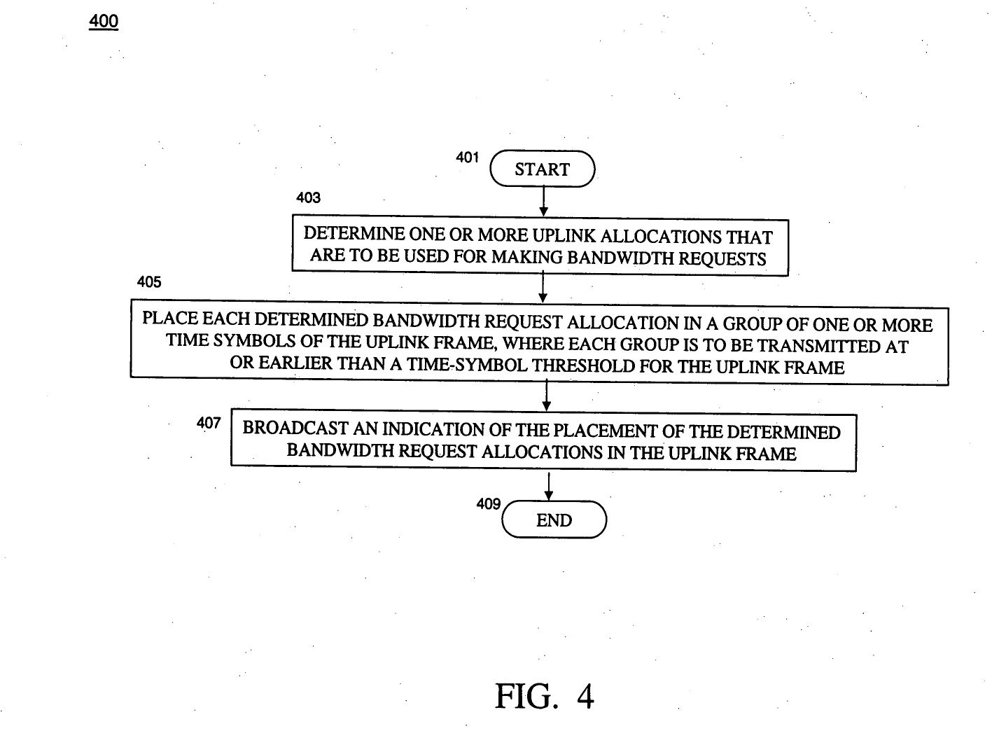

Operation of embodiments in accordance with the present invention occurs substantially as follows, first with reference to FIGS. 3-5. FIG. 4 is a logic flow diagram of functionality performed in accordance with multiple embodiments of the present invention. Logic flow 400 begins (401) when a processing unit (such as processing unit 325 of communication device 321, for example) determines (403) one or more uplink allocations that are to be used for making a bandwidth requests. The processing unit places (405) each of these bandwidth request allocations in a group of one or more time symbols of the uplink frame. Each of these time-symbol groups is to be transmitted at or earlier than a time-symbol threshold for the uplink frame.

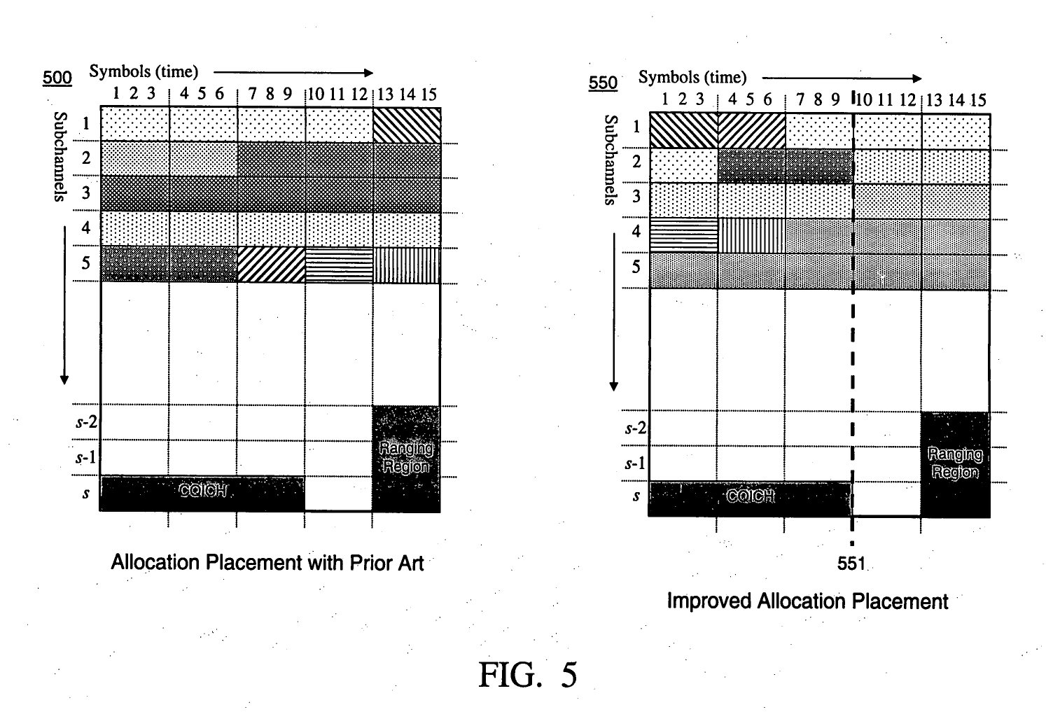

For example, FIG. 5 is a block diagram depiction of two illustrative examples of uplink frames. Uplink frame 500 illustrates the placement of allocations in accordance with prior art techniques, while uplink frame 550 illustrates the placement of allocations in accordance with multiple embodiments of the present invention. In both uplink frames 500 and 550, hashed areas represent bandwidth request allocations, different hashing patterns representing allocations for different bandwidth requests, while non-hashed boxes represent bandwidth allocations for other purposes.

FIG. 5 depicts time-symbol threshold 551 for uplink frame 550. In uplink frame 550, a first bandwidth request allocation is depicted as being placed in the group of time-symbols 1-3 on subchannel 1, a second bandwidth request allocation is depicted as being placed in the group of time-symbols 4-6 on subchannel 1, a third bandwidth request allocation is depicted as being placed in the group of time-symbols 1-3 on subchannel 4, and a fourth bandwidth request allocation is depicted as being placed in the group of time-symbols 4-6 on subchannel 4. Each of these time-symbol groups is to be transmitted in the uplink frame before time-symbol threshold 551. In fact, time-symbols 1-9 on subchannels 1-s are to be transmitted at or earlier than time-symbol threshold 551. In contrast, uplink frame 500 illustrates the placement of allocations in accordance with prior art techniques. Notably, the bandwidth request allocations (depicted by the hashed areas) are not deliberately placed in earlier time-symbol groups since there is no time-symbol threshold before which bandwidth request allocations are to be placed.

Returning now to logic flow 400, the processing unit then broadcasts (407), perhaps via a transceiver depending on the embodiment, an indication of the placement of each bandwidth request allocation in the uplink frame. Depending on the embodiment, the indication may take the form of a mapping that conveys the placement of uplink allocations within the uplink frame. The well-known UL-MAP message, which is transmitted to remote units on the downlink (DL) in 802.16d/e systems, is one example of such a mapping that may be broadcast. Logic flow 400 then ends (409).

By placing bandwidth request allocations earlier in the uplink frame (i.e., at or before the time-symbol threshold), remote units are able to send their bandwidth requests to a scheduler sooner and thereby receive a bandwidth grant for an uplink data transfer with less delay. An example of how this transfer start-up delay might be reduced in practice can be found by comparing timing diagrams 100 and 200. FIG. 2 is a timing diagram of an example of a two-staged bandwidth request/grant procedure in accordance with multiple embodiments of the present invention.

As in timing diagram 100, a remote unit is allocated a small bandwidth so that it can send in its request for additional bandwidth. In response to receiving (210) an allocation to request additional bandwidth, the remote unit sends a bandwidth request (220) in the portion of the uplink frame that it was allocated. Because the portion of the uplink frame allocated in timing diagram 200 is sufficiently early in the uplink frame (in timing diagram 100, it was not), the bandwidth request is sent (220) sufficiently early for the uplink (UL) scheduler to schedule and send (230) a bandwidth grant in the following frame. Thus, the remote unit receives a bandwidth grant and can then send (240) its uplink data in the next frame. As illustrated in timing diagram 200, the actual transfer start-up delay experienced by the remote unit may be reduced from approximately six frames to four.

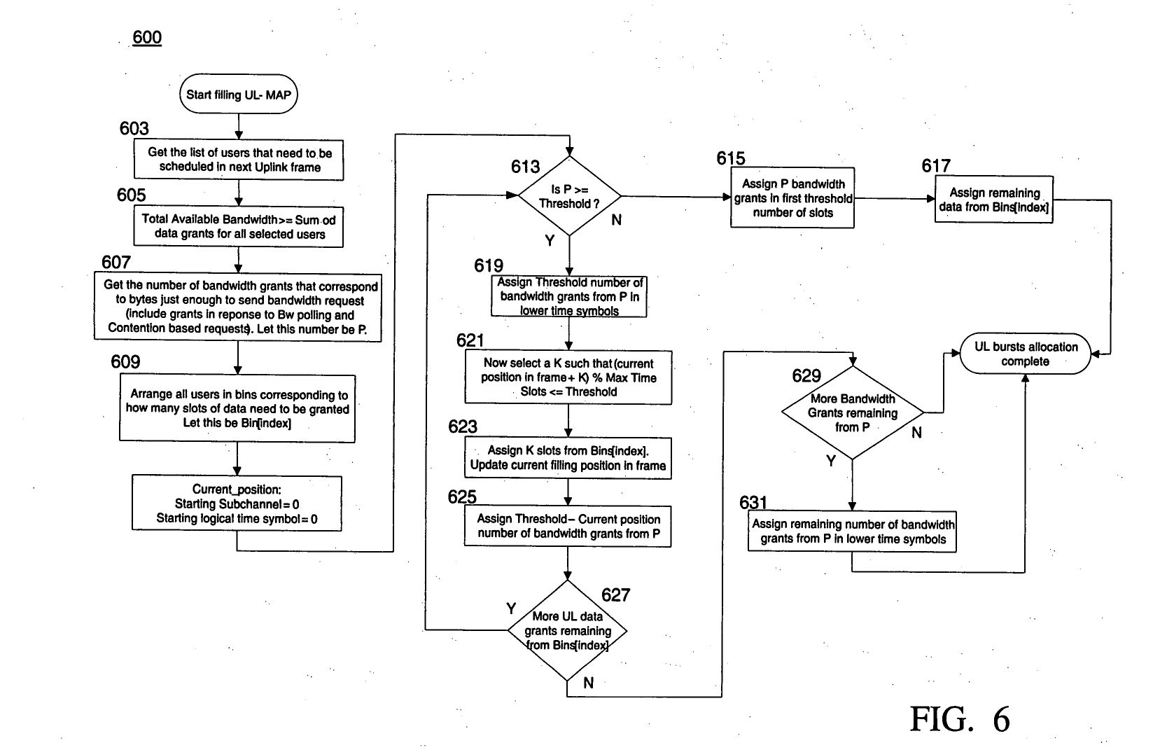

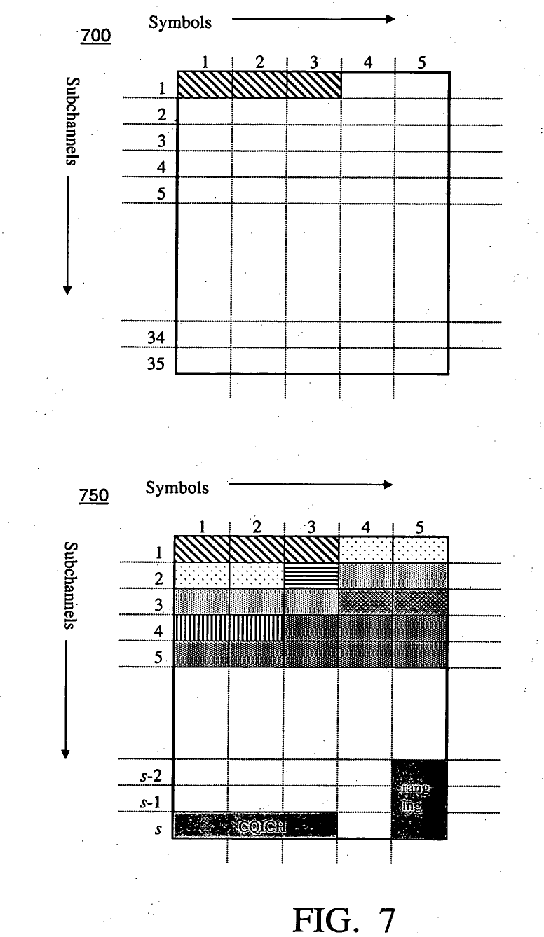

A discussion of certain embodiments in greater detail follows with reference to FIGS. 6 and 7. In particular, a specific algorithm is provided for placing the grants (i.e., allocations) in the UL frame. The algorithm addresses the placement of allocations for Bandwidth Requests (BRs) and for other uplink data transfers from the remote units (RUs). Since the algorithm places allocations for BRs differently than those for other data transfers, the various sources of BRs and various types of associated grants/allocations need to be differentiated. For 802.16e systems, these may be categorized into two types as follows:

Type I:

1. Bandwidth Grants made for polling RU uplink ertPS connections;
2. Bandwidth Grants made for polling RU uplink rtPS connections;
3. Bandwidth Grants made for polling RU uplink nrtPS connections;
4. Bandwidth Grant made for a RU when RU used contention-based Bandwidth Request region and contention was successful.
   Type II:
1. Bandwidth Grant made for ertPS connection when RU used CQICH codeword to send the Bandwidth Request;
2. Bandwidth Grants made for Piggybacked BRs in the uplink data traffic;
3. Bandwidth Grants made for requests made via Grant Management Subheader's Extended Request field.

Type I Bandwidth Grants are typically small allocations, just sufficient for the RU to then send a Bandwidth Request (in form of MAC Signaling Header I or II from 802.16e spec) for the amount of bytes desired. Also, for Type I Bandwidth Grants, placement in the time-domain of the UL frame area governs when the RU can make a BR for uplink data and thereby governs when the RU can start the uplink data transfer. Type II Bandwidth Grants are typically larger grants that are intended for RUs to use for sending uplink data. Thus, any Bandwidth Requests embedded by RUs represent “stolen” bandwidth, since these grants are intended/scheduled for the purpose of uplink data (or CQI).

The difference between the Type I and Type II BRs is that for Type I, the scheduler scheduled space for the RU to send in a BR for data transfer, while for Type II, the scheduler scheduled space for the RU to send in uplink data (or CQI) but the RU chose to steal it in order to send in more BRs. This difference creates an opportunity to prioritize in time the scheduling of the known BRs (Type I) over the “unknown” BRs (Type II). Thus, in effect, the response to Type I BRs will be faster than to the others. Doing this can provide an obvious advantage from the system performance perspective since the 802.16e UL is based on the scheduling. The faster the turn around time, the better the expected system performance.

To summarize, typically an uplink scheduler outputs a list of connections and associated slots that each connection/user occupies in the uplink frame. Efficient placement of the uplink bursts, corresponding to the allocation for the RU to send up its bandwidth request, can lead to significantly faster uplink scheduling. Faster uplink scheduling, in turn, may result in a better performing system.

FIG. 6 is a more detailed logic flow diagram of functionality performed in accordance with certain embodiments of the present invention. Logic flow 600 details one algorithm for doing the placement of allocations within an uplink frame. In these embodiments, it is the UL-MAP that is filled and then conveyed to the RUs to indicate their allocated portions of the uplink frame. The first step is getting (603) the list of uplink connections (U) that have been chosen to be scheduled in an uplink frame. Clearly, at this time (605)

$${\sum }_{i = 0}^{U} Data\_to {\_schedule}_{ i} = \begin{matrix}Total available UL bandwidth \\ ( \begin{matrix}excluding signaling channels \\ overhead for CQICH , \\ ranging channel , and ACKCH \end{matrix} ) .\end{matrix}$$

Place (607, 609) connections corresponding to Type II bandwidth grants in bins whose index is the number of slots to be allocated for this connection. For example, Bin[1]=S₁ denotes that there are S₁ connections with 1 slot worth of data each to be filled in the UL frame. Similarly, Bin[2]=S₂ denotes that there are S₂ connections that have 2 slots worth of data each to be filled, and in general Bin[i]=S₁ denotes there are / connections each with data equal to S₁ slots each to be filled in a UL frame. With this

$${\sum }_{i = 1}^{l} {S}_{i} * i = T$$

where T=Total slots available in Uplink for bursts scheduling. Let's say U=total number of connections chosen for scheduling. Here U=P+D, where
P=Number of connections with allocations intended for RU to send in Bandwidth Request. This corresponds to number of Bandwidth Grants from Type I (as discussed before).
And,

$$D = {\sum }_{i = 1}^{l} {S}_{i} .$$

That is D is the number of Bandwidth Grants from Type II (as discussed before) that have been chosen for scheduling in Uplink frame and correspond to an allocation for RU to send in a data burst. All the D users are distributed into bins numbered 1, 2, 3, 4 . . . / where/=maximum number of slots to be allocated for any connection that will be occupying some position in current frame.

Let parameter FAST-BR-THRESHOLD define maximum desired time symbol to be assigned to a bandwidth grant from P bucket.
Case 1 (Trivial case)—If P=0, proceed with assigning data from D bucket (from in Bin[i]) serially.
Case 2—If (613) P is less than or equal to FAST-BR-THRESHOLD, then allocate (615) the first FAST-BR-THRESHOLD time symbols from UL frame on starting subchannel to each P. Then, proceed with assigning (617) data from D bucket (from in Bin[i]) serially.
Case 3—If (613) P is greater than FAST-BR-THRESHOLD, then (619, 621, 623, 625) select an optimum number of slots to schedule, say k, such that
   1≦mod(current₁₃ position+k,MAX₁₃ TIME₁₃ SLOTS)≦FAST₁₃ BR₁₃ THRESHOLD
   where current₁₃ position is the time slot number of current filling location. Once such a k is selected, allocate data such that one or more bursts occupy k slots. Increment current₁₃ position in frame and decrement bin from which data burst was selected. With the above calculation, current₁₃ position is always within FAST-BR-THRESHOLD and at this point more bandwidth grants from P bucket can be allocated. This step is repeated (627, 629, 631) until P and D bins are exhausted.

FIG. 7 is a block diagram depiction of two illustrative examples of uplink frames in accordance with certain embodiments of the present invention. In the present example, a 5 ms frame with a 70/30 split TDD system, results in 15 time symbols per UL frame. With PUSC, 3 time symbols and 1 subchannel make 1 uplink slot. Thus, uplink frame 700 is depicted with 5 uplink time slots on the x-axis and, assuming 1024 FFT and PUSC, with 35 subchannels on the y-axis.

The parameter FAST-BR-THRESHOLD defines the maximum time slot in which an UL allocation for an RU to send in Bandwidth Request (Type I) should be placed. For example, if this parameter is 3, then, the disclosed algorithm should place all such allocations in time symbols 1, 2 and/or 3. Note that generally the smaller the value of this parameter is, the sooner Type I BRs will be received and the sooner the scheduler will be able to grant the BRs.

If P<=FAST-BR-THRESHOLD, then allocate all P allocations in first subchannel occupying P slots (each allocation will be 6-bytes and can fit into one slot). Then assign the rest of the uplink bursts rastering horizontally from lowest time symbol to highest and then wrapping around to next higher subchannel in the frame. Uplink frame 750 depicts an example frame resulting from the algorithm with FAST-BR-THRESHOLD=3. Hashed areas represent Type I Bandwidth grants for RUs to send in Bandwidth Requests.

After placing the first bandwidth request allocation, in slots 1-3 of subchannel 1, the current slot position to be filled would be 4. If P>FAST-BR-THRESHOLD, select a k such that
1≦mod(current₁₃ position+k,MAX₁₃ TIME₁₃ SLOTS)≦FAST₁₃ BR₁₃ THRESHOLD
If found k, pick users from bins such that sum of slots of selected users is k. If not found such a k, one from P and re-do computation of k. Now schedule 1, 2 or 3 users from P depending upon where the current-position is. If more P users remain, then re-do computation for next value of k. Otherwise, perform normal allocations until all user bins are exhausted. Special case: If at some point only users from P list are remaining, then schedule vertically in time slots 1, 2 and 3.

Uplink frame 750 depicts an example frame resulting from this algorithm. Note that all Bandwidth Grants that were made for RUs to send in Bandwidth Requests have been expedited in time so that they arrive sooner at the scheduler. This enables the scheduler to respond sooner, thereby, improving connection setup times, and decreasing perceived latency of the overall system.

A sample code embodiment is provided below for implementing such an algorithm as this:

#include <stdio.h>
#include <string.h>
#define MAX_SLOTS_PER_SS 20
#define MAX_TIME_SLOTS 5
#define MAX_SUBCHANS 35
/* prototypes */

| | |
|---|---|
| int | find_optimum_slots( ); |
| void | print_map( ); |
| void | get_data( ); |
| int | space_remaining( ); |
| int | data_remaining( ); |
| void | allocate_p( ); |
| void | allocate_data( ); |
| void | init_map( ); |

/* Globals */

| int | THRESHOLD; | |
|---|---|---|
| int | ul_data[MAX_SLOTS_PER_SS]; | |
| int | P; | /* number of polling grants or 6 -byte bw |

grants */

| | |
|---|---|
| int | ul_map[MAX_SUBCHANS] [MAX_TIME_SLOTS]; |
| int | cur_pos = 0; |
| int | bins_to_schedule[10]; |

/* Main function */
main( )
{

get_data( );
init_map( );
while ((data_remaining( ) > 0) && (space_remaining( ) > 0))
{

allocate_p( );
allocate_data( );

}
print_map( );

}
/* Sub-functions */
/* initialize output - UL-MAP to all unassigned slots */

| | |
|---|---|
| void | init_map( ) |

{

| | |
|---|---|
| int | i, j; |

for (i = 0; i < MAX_SUBCHANS; i++)

for (j = 0; j < MAX_TIME_SLOTS; j++)

ul_map[i] [j] = −1;

}
/* allocate data bursts */

| | |
|---|---|
| void | allocate_data( ) |

{

| | |
|---|---|
| int | data_available = 0; |
| int | users_to_schedule; |
| int | selected_bin; |
| int | i; |
| int | j; |

for (i = 0; i < MAX_SLOTS_PER_SS; i++)
{

data_available += (ul_data[i] * (i + 1));

}
/* if no data to schedule, advance cur_pos to low time symbols */
if (data_available == 0)
{

for (i = 0; i < MAX_TIME_SLOTS − THRESHOLD; i++)
{

cur_pos++;

}
return;

}
/* if bandwidth grants are waiting to be scheduled */
if (P > 0)
{

/*

data available, find optimum slots so that we stop at next low time symbol

*/
users_to_schedule = find_optimum_slots( );
for (i = 0; i < users_to_schedule; i++)
{

for (j = 0; j < bins_to_schedule[i] + 1; j++)
{

ul_map[cur_pos / MAX_TIME_SLOTS] [cur_pos % MAX_TIME_SLOTS] =

bins_to_schedule[i] + 1;

cur_pos++;

}
ul_data[bins_to_schedule[i]]−−;

}

}
else
{

/* allocate next user */
for (i = 0; i < MAX_SLOTS_PER_SS; i++)
{

if (ul_data[i] > 0)
{

selected_bin = i;
break;

}

}
for (j = 0; j < selected_bin + 1; j++)
{

ul_map[cur_pos / MAX_TIME_SLOTS] [cur_pos % MAX_TIME_SLOTS] = selected_bin

+ 1;

cur_pos++;

}
ul_data[selected_bin]−−;

}

}
/* find optimum burst to place at current position */

| | |
|---|---|
| int | find_optimum_slots( ) |
| { | |

| | |
|---|---|
| int | offset; |
| int | bin_select; |
| int | k; |
| int | result = 0; |
| int | i; |

/* Check for ending at symbol offset 0 to THRESHOLD−1 */
for (offset = 0; offset < THRESHOLD; offset++)
{

bin_select = (MAX_TIME_SLOTS − 1) − (cur_pos % MAX_TIME_SLOTS) + offset;
if (bin_select == 0)
{

if (ul_data[bin_select] <= 0)
{

continue;

}

```
}
/*
  find available data in bins that are non-empty and are multiples
  of cur_pos+desired offset
*/
for (k = 0; k < (MAX_SLOTS_PER_SS − bin_select) / MAX_TIME_SLOTS; k++)
{
```

if (ul_data[bin_select + (k * MAX_TIME_SLOTS)] > 0)
{

bins_to_schedule[result] = bin_select + (k * MAX_TIME_SLOTS);
result++;
return result;

}

}

}
/* found nothing suitable, schedule one smallest data grant */
for (i = 0; i < MAX_SLOTS_PER_SS; i++)
{

if (ul_data[i] > 0)
{

bins_to_schedule[result] = i;
result++;
break;

}

}
return result;

}
/* get input for this program */

| | |
|---|---|
| void | get_data( ) |

{

| | |
|---|---|
| int | i; |
| int | remainder = MAX_SUBCHANS * MAX_TIME_SLOTS; |

for (i = 0; i < MAX_SLOTS_PER_SS; i++)

ul_data[i] = 0;

printf(“\nEnter desired Threshold: ”);
scanf(“%d”, &THRESHOLD);
printf(“\nEnter num of type I bw grants (P): ”);
scanf(“%d”, &P);
remainder −= P;
if (remainder <= 0)

return;

for (i = 0; i < MAX_SLOTS_PER_SS; i++)
{

printf(“Enter num of users with %d slots (type II grants in Bin[%d] or S[%d]):

”, i + 1, i + 1, i + 1);

scanf(“%d”, &ul_data[i]);
remainder −= (ul_data[i] * (i + 1));
if (remainder <= 0)
return;

}

}
/* print output */

| | |
|---|---|
| void | print_map( ) |

{

| | |
|---|---|
| int | subch; |
| int | time_slot; |

printf(“\nBelow is the UL-MAP generated with the idea suggested in this

disclosure”);

| printf(“\nX-axis is time slots; Y-axis is subchannels”); | | |
|---|---|---|
| printf(“\nLegend: | P | = Bandwidth Grant to send Bandwidth Request”); |
| printf(“\n | 1-20 | = User data. Number indicates the size of data grant”); |
| printf(“\n | −1 | = Unassigned slot”); |

printf(“\nNotice that using our algorithm, all Bandwidth Grants that are made to

send Bandwidth Requests appear earlier in time resulting in faster Uplink
Scheduling”);

printf(“\n”);
for (time_slot = 0; time_slot < MAX_TIME_SLOTS; time_slot++)

printf(“\t%d”, time_slot);

for (subch = 0; subch < MAX_SUBCHANS; subch++)
{

printf(“\n%d”, subch);
for (time_slot = 0; time_slot < MAX_TIME_SLOTS; time_slot++)
{
if (ul_map[subch][time_slot] == 0)

printf(“\tP”);

else

printf(“\t%d”, ul_map[subch][time_slot]);

}

}
printf(“\nDone.\n”);

}
/* allocate bandwidth grant for bandwidth request purposes */

| | |
|---|---|
| void | allocate_p( ) |

{

if (P <= 0)

return;

while ((cur_pos % MAX_TIME_SLOTS) < THRESHOLD)
{

if (P > 0)
{

ul_map[cur_pos / MAX_TIME_SLOTS][cur_pos % MAX_TIME_SLOTS] = 0;
++cur_pos;
−−P;

}
else
{

break;

}

}

}
/* calculate remaining data to be scheduled */

| | |
|---|---|
| int | data_remaining( ) |

{

| | |
|---|---|
| int | i; |
| int | sum = 0; |

for (i = 0; i < MAX_SLOTS_PER_SS; i++)

sum += (ul_data[i] * (i + 1));

sum += P;
return sum;

}
/* calculate if space is remaining in UL frame */

| | |
|---|---|
| int | space_remaining( ) |

{

if (cur_pos < MAX_SUBCHANS * MAX_TIME_SLOTS)

return 1;

else

return 0;

}

Sample code output follows:

Enter desired Threshold: 2
Enter num of type I bw grants (P): 20
Enter num of users with 1 slots (type II grants in Bin[1] or S[1]): 0
Enter num of users with 2 slots (type II grants in Bin[2] or S[2]): 0
Enter num of users with 3 slots (type II grants in Bin[3] or S[3]): 0
Enter num of users with 4 slots (type II grants in Bin[4] or S[4]): 0
Enter num of users with 5 slots (type II grants in Bin[5] or S[5]): 0
Enter num of users with 6 slots (type II grants in Bin[6] or S[6]): 0
Enter num of users with 7 slots (type II grants in Bin[7] or S[7]): 0
Enter num of users with 8 slots (type II grants in Bin[8] or S[8]): 0
Enter num of users with 9 slots (type II grants in Bin[9] or S[9]): 0
Enter num of users with 10 slots (type II grants in Bin[10] or S[10]): 0
Enter num of users with 11 slots (type II grants in Bin[11] or S[11]): 0
Enter num of users with 12 slots (type II grants in Bin[12] or S[12]): 0
Enter num of users with 13 slots (type II grants in Bin[13] or S[13]): 0
Enter num of users with 14 slots (type II grants in Bin[14] or S[14]): 0
Enter num of users with 15 slots (type II grants in Bin[15] or S[15]): 0
Enter num of users with 16 slots (type II grants in Bin[16] or S[16]): 0
Enter num of users with 17 slots (type II grants in Bin[17] or S[17]): 0
Enter num of users with 18 slots (type II grants in Bin[18] or S[18]): 0
Enter num of users with 19 slots (type II grants in Bin[19] or S[19]): 0
Enter num of users with 20 slots (type II grants in Bin[20] or S[20]): 0
Below is the UL-MAP generated.
X-axis is time slots; Y-axis is subchannels

| Legend : | P | = Bandwidth Grant to send Bandwidth Request |
|---|---|---|
| | 1-20 | = User data. Number indicates the size of data grant |
| | −1 | = Unassigned slot |

Notice that using this algorithm, Bandwidth Grants that are made to send Bandwidth
Requests appear earlier in time allowing for faster uplink scheduling

| | 0 | 1 | 2 | 3 | 4 |
|---|---|---|---|---|---|
| 0 | P | P | −1 | −1 | −1 |
| 1 | P | P | −1 | −1 | −1 |
| 2 | P | P | −1 | −1 | −1 |
| 3 | P | P | −1 | −1 | −1 |
| 4 | P | P | −1 | −1 | −1 |
| 5 | P | P | −1 | −1 | −1 |
| 6 | P | P | −1 | −1 | −1 |
| 7 | P | P | −1 | −1 | −1 |
| 8 | P | P | −1 | −1 | −1 |
| 9 | P | P | −1 | −1 | −1 |
| 10 | −1 | −1 | −1 | −1 | −1 |
| 11 | −1 | −l | −1 | −1 | −1 |
| 12 | −1 | −1 | −1 | −1 | −1 |
| 13 | −1 | −1 | −1 | −1 | −1 |
| 14 | −1 | −1 | −1 | −1 | −1 |
| 15 | −1 | −1 | −1 | −1 | −1 |
| 16 | −1 | −1 | −1 | −1 | −1 |
| 17 | −1 | −1 | −1 | −1 | −1 |
| 18 | −1 | −1 | −1 | −1 | −1 |
| 19 | −1 | −1 | −1 | −1 | −1 |
| 20 | −1 | −1 | −1 | −1 | −1 |
| 21 | −1 | −1 | −1 | −1 | −1 |
| 22 | −1 | −1 | −1 | −1 | −1 |
| 23 | −1 | −1 | −1 | −1 | −1 |
| 24 | −1 | −1 | −1 | −1 | −1 |
| 25 | −1 | −1 | −1 | −1 | −1 |
| 26 | −1 | −1 | −1 | −1 | −1 |
| 27 | −1 | −1 | −1 | −1 | −1 |
| 28 | −1 | −1 | −1 | −1 | −1 |
| 29 | −1 | −1 | −1 | −1 | −1 |
| 30 | −1 | −1 | −1 | −1 | −1 |
| 31 | −1 | −1 | −1 | −1 | −1 |
| 32 | −1 | −1 | −1 | −1 | −1 |
| 33 | −1 | −1 | −1 | −1 | −1 |
| 34 | −1 | −1 | −1 | −1 | −1 |
| Done. | | | | | |

Enter desired Threshold: 2
Enter num of type I bw grants (P): 17
Enter num of users with 1 slots (type II grants in Bin[1] or S[1]): 1
Enter num of users with 2 slots (type II grants in Bin[2] or S[2]): 1
Enter num of users with 3 slots (type II grants in Bin[3] or S[3]): 2
Enter num of users with 4 slots (type II grants in Bin[4] or S[4]): 1
Enter num of users with 5 slots (type II grants in Bin[5] or S[5]): 1
Enter num of users with 6 slots (type II grants in Bin[6] or S[6]): 1
Enter num of users with 7 slots (type II grants in Bin[7] or S[7]): 1
Enter num of users with 8 slots (type II grants in Bin[8] or S[8]): 1
Enter num of users with 9 slots (type II grants in Bin[9] or S[9]): 1
Enter num of users with 10 slots (type II grants in Bin[10] or S[10]): 1
Enter num of users with 11 slots (type II grants in Bin[11] or S[11]): 1
Enter num of users with 12 slots (type II grants in Bin[12] or S[12]): 1
Enter num of users with 13 slots (type II grants in Bin[13] or S[13]): 1
Enter num of users with 14 slots (type II grants in Bin[14] or S[14]): 1
Enter num of users with 15 slots (type II grants in Bin[15] or S[15]): 1
Enter num of users with 16 slots (type II grants in Bin[16] or S[16]): 1
Enter num of users with 17 slots (type II grants in Bin[17] or S[17]): 0
Enter num of users with 18 slots (type II grants in Bin[18] or S[18]): 0
Enter num of users with 19 slots (type II grants in Bin[19] or S[19]): 1
Below is the UL-MAP generated.
X-axis is time slots; Y-axis is subchannels

| Legend: | 0 | = Bandwidth Grant to send Bandwidth Request |
|---|---|---|
| | 1-20 | = User data. Number indicates the size of data grant |
| | −1 | = Unassigned slot |

Notice that using our algorithm, Bandwidth Grants that are made to send Bandwidth
Requests appear earlier in time allowing for faster uplink scheduling

| | 0 | 1 | 2 | 3 | 4 |
|---|---|---|---|---|---|
| 0 | P | P | 3 | 3 | 3 |
| 1 | P | P | 3 | 3 | 3 |
| 2 | P | P | 8 | 8 | 8 |
| 3 | 8 | 8 | 8 | 8 | 8 |
| 4 | P | P | 13 | 13 | 13 |
| 5 | 13 | 13 | 13 | 13 | 13 |
| 6 | 13 | 13 | 13 | 13 | 13 |
| 7 | P | P | 4 | 4 | 4 |
| 8 | 4 | P | 9 | 9 | 9 |
| 9 | 9 | 9 | 9 | 9 | 9 |
| 10 | 9 | P | 14 | 14 | 14 |
| 11 | 14 | 14 | 14 | 14 | 14 |
| 12 | 14 | 14 | 14 | 14 | 14 |
| 13 | 14 | P | 1 | 2 | 2 |
| 14 | P | P | 5 | 5 | 5 |
| 15 | 5 | 5 | 6 | 6 | 6 |
| 16 | 6 | 6 | 6 | 7 | 7 |
| 17 | 7 | 7 | 7 | 7 | 7 |
| 18 | P | P | 10 | 10 | 10 |
| 19 | 10 | 10 | 10 | 10 | 10 |
| 20 | 10 | 10 | 11 | 11 | 11 |
| 21 | 11 | 11 | 11 | 11 | 11 |
| 22 | 11 | 11 | 11 | 12 | 12 |
| 23 | 12 | 12 | 12 | 12 | 12 |
| 24 | 12 | 12 | 12 | 12 | 12 |
| 25 | 15 | 15 | 15 | 15 | 15 |
| 26 | 15 | 15 | 15 | 15 | 15 |
| 27 | 15 | 15 | 15 | 15 | 15 |
| 28 | 16 | 16 | 16 | 16 | 16 |
| 29 | 16 | 16 | 16 | 16 | 16 |
| 30 | 16 | 16 | 16 | 16 | 16 |
| 31 | 16 | 19 | 19 | 19 | 19 |
| 32 | 19 | 19 | 19 | 19 | 19 |
| 33 | 19 | 19 | 19 | 19 | 19 |
| 34 | 19 | 19 | 19 | 19 | 19 |
| Done. | | | | | |

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. Terminology derived from the word “indicating” (e.g., “indicates” and “indication”) are intended to encompass all the various techniques available for communicating or referencing the object being indicated. Some, but not all examples of techniques available for communicating or referencing the object being indicated include the conveyance of the object being indicated, the conveyance of an identifier of the object being indicated, the conveyance of information used to generate the object being indicated, the conveyance of some part or portion of the object being indicated, the conveyance of some derivation of the object being indicated, and the conveyance of some symbol representing the object being indicated. The terms program, computer program, and computer instructions, as used herein, are defined as a sequence of instructions designed for execution on a computer system. This sequence of instructions may include, but is not limited to, a subroutine, a function, a procedure, an object method, an object implementation, an executable application, an applet, a servlet, a shared library/dynamic load library, a source code, an object code and/or an assembly code.

What is claimed is:

1. A method for uplink allocation placement in an uplink frame comprising:
determining at least one uplink allocation, from a plurality of uplink allocations, that is to be used for making a bandwidth request to produce at least one bandwidth request allocation;
placing the at least one bandwidth request allocation in a group, of one or more time symbols of the uplink frame, that is to be transmitted at or earlier than a time-symbol threshold for the uplink frame;
broadcasting an indication of the placement of the at least one bandwidth request allocation in the uplink frame.

2. The method of claim 1, wherein broadcasting the indication of the placement of the at least one bandwidth request allocation in the uplink frame comprises
broadcasting a mapping that conveys the placement of uplink allocations within the uplink frame.

3. The method of claim 2, wherein broadcasting the mapping that conveys the placement of uplink allocations within the uplink frame comprises
broadcasting a UL-MAP message in a downlink (DL) frame.

4. The method of claim 1, wherein determining the at least one uplink allocation that is to be used for making a bandwidth request comprises
determining at least one uplink allocation that allocates uplink bandwidth sufficient for transmitting only a bandwidth request.

5. The method of claim 1, wherein determining the at least one uplink allocation that is to be used for making a bandwidth request comprises
determining at least one bandwidth grant that is of a type intended to be used for making bandwidth requests to produce the at least one bandwidth request allocation.

6. The method of claim 5, wherein determining at least one bandwidth grant that is of a type intended to be used for making bandwidth requests comprises
determining at least one uplink allocation for a Type I Bandwidth Grant to produce at least one bandwidth request allocation.

7. The method of claim 6, wherein the Type I Bandwidth Grant comprises at least one of
a Bandwidth Grant intended to be used for polling remote unit uplink ertPS connections,
a Bandwidth Grant intended to be used for polling remote unit uplink rtPS connections,
a Bandwidth Grant intended to be used for polling remote unit uplink nrtPS connections, and
a Bandwidth Grant intended to be used for a remote unit when a contention-based Bandwidth Request region was used and contention was successful.

8. The method of claim 1, further comprising:
placing remaining uplink allocations, from the plurality of uplink allocations, in portions of the uplink frame that remain after the placement of the at least one bandwidth request allocation.

9. The method of claim 8, wherein placing the remaining uplink allocations in the portions of the uplink frame that remain comprises
placing Type II Bandwidth Grants in portions of the uplink frame that remain after the placement of the at least one bandwidth request allocation, wherein the Type II Bandwidth Grants comprise at least one of
a Bandwidth Grant intended to be used for ertPS connection when a remote unit used a CQICH (Channel Quality Indicator Channel) codeword to send a bandwidth request,
a Bandwidth Grant intended to be used for piggybacked bandwidth requests in uplink data traffic, and
a Bandwidth Grant intended to be used for requests made via Grant Management Subheader's Extended Request field.

10. The method of claim 1, wherein the uplink frame comprises a plurality of frequency subchannels on each of which a plurality of time symbols are to be transmitted during a period of time.

11. A communication device comprising:
a transceiver;
a processing unit, communicatively coupled to the transceiver,
adapted to determine at least one uplink allocation, from a plurality of uplink allocations, that is to be used for making a bandwidth request to produce at least one bandwidth request allocation,
adapted to place the at least one bandwidth request allocation in a group of one or more time symbols of an uplink frame that is to be transmitted at or earlier than a time-symbol threshold for the uplink frame, and
adapted to broadcast, via the transceiver, an indication of the placement of the at least one bandwidth request allocation in the uplink frame.

12. The communication device of claim 11, wherein the communication device comprises at least one of
a base transceiver station (BTS),
an access point (AP),
a base station (BS),
a WLAN (wireless local area network) station
a radio access network (AN), and
an access network (AN).

13. The communication device of claim 11, wherein the uplink frame comprises a plurality of frequency subchannels on each of which a plurality of time symbols are to be transmitted during a period of time.

14. The communication device of claim 11, wherein the processing unit being adapted to broadcast the indication of the placement of the at least one bandwidth request allocation in the uplink frame comprises
the processing unit being adapted to broadcast, via the transceiver, a mapping that conveys the placement of uplink allocations within the uplink frame.

15. The communication device of claim 11, wherein the processing unit being adapted to broadcast the mapping that conveys the placement of uplink allocations within the uplink frame comprises
the processing unit being adapted to broadcast, via the transceiver, a UL-MAP message in a downlink (DL) frame.
